(19) United States
(12) Patent Application Publication
(10) Pub. No.: US 2007/0018890 A1
(43) Pub. Date: Jan. 25, 2007

(54) Multi-sensor wayfinding device

(76) Inventor: Vladimir A. Kulyukin, North Logan, UT (US)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(21) Appl. No.: 11/490,599

(22) Filed: Jul. 21, 2006

Related U.S. Application Data
(60) Provisional application No. 60/701,745, filed on Jul. 22, 2005.

(51) Int. Cl. G01S 5/14; G01S 3/02

(52) U.S. Cl. 342/357.14; 342/451

(57) ABSTRACT

A multi-sensor device and a method for indoor and outdoor navigation are presented. The objective is a ubiquitous localization and tracking methodology that relies on multiple sensors to localize and track a navigator in a given environment. The method is based on fusing information from multiple sensors. Sensor fusion is based on the Dempster-Shafer theory of evidence. The wearable version of the device fuses data from a GPS receiver, a wireless signal detector, a pedometer, and a digital compass. The version of the device that can be mounted on a robotic base fuses data from a laser range finder and a radio frequency identification (RFID) reader. The indoor localization is done by using wireless signals already available in many indoor environments due to the ubiquitous use of wireless IEEE Wi-Fi networks. One advantage of this approach is that it does not require any modification of the environment. The outdoor GPS-based localization overcomes the problem of signal drift by computing standard deviation ellipses of signal coordinates collected at pre-selected landmarks.

### RELATED APPLICATIONS

This application claims priotity to U.S. Patent Applicaiton No. 60/701,745 filed on Jul. 22, 2005, entitled “Multi-sensor wayfinding device”, and is incorporated herin by reference.

### FIELD OF THE INVENTION

The present invention relates to a device and method for localizing one's position and providing directional guidance to a desired destination. The device is one wherein premapped sensor signals are combined to provide location information coupled to a stored computerized mapping of information and outputting directional information to the user.

### BACKGROUND

When faced with learning how to navigate in a new setting an individual will rely on maps that contain a visual representation of the locations of areas of interest. There are however, instances where the individual is not able to refer to the visual cues in the environment and the recordation on maps. This could be the result of visual impairment of the individual or of some other occupation that keeps the individual form being able to refer to either a map or to the localization cues. For example an emergency worker may be occupied with equipment operation, need to navigate in unfamiliar areas and be unable to simultaneously locate their position on a map. A major problem for the visually impaired is independent navigation. The visually impaired must rely on others to learn their way around a new setting, which reduces their sense of independence. There is a need for a device to help such individuals to navigate or learn new routes. Various techniques have been developed in an attempt to meet these needs. All provide partial navigation support but fail to provide complete indoors and out of doors navigation support.

Computer vision has been used in various assisted navigation devices. As an example, Aoki (A. Aoki, B. Schiele, and A. Pentland, Realtime Personal Positioning System for a Wearable Computer, in Fourth Joint Conference on Information Systems, San Francisco, Calif., 1999) developed a personal positioning system for wearable computers based on computer vision techniques. Images captured from the head mounted camera are compared against a trained set to give the user context and location information. Several GPS-based solutions have attempted to address these. These systems use GPS as its primary means for determining position and orientation. GPS-Talk© is a GPS-based navigation system for the visually impaired developed by the Sendero Group, LLC (http://www.senderogroup.com/gpsflyer.htm. What is GPS-Talk? Sendero Group, LLC). Using GPS-Talk©, visually impaired users can access various points of interest in different contexts, e.g. car, taxi, bus, or home. The system consists of a talking user interface, digital maps, a GPS antenna and a talking notebook computer. MOBIC is a GPS-based travel aid for the blind and elderly (H. Petrie, V. Johnson, T. Strothotte, A. Raab, S. Fritz, and R. Michael, MOBIC: Designing a Travel Aid for Blind and Elderly People, Journal of Navigation, Royal Institute of Navigation, 1(49):45-52, 1996). The system allows the user to develop journey plans and then recites those plans to the user through speech synthesis. The system is implemented on a handheld computer with preloaded digital maps. Drishti is a GPS-based navigation system for the visually impaired developed by Hilal, Moore, and Ramachandran at the University of Florida at Gainesville (A. Hilal and B. Moore, S. Ramachandran, Drishti: An Integrated Navigation System for Visually Impaired and Disabled, in Proceedings of the 5th International Symposium on Wearable Computer, Zurich, Switzerland, October 2001). The system computes optimized routes based on user preference, temporal constraints, and dynamic obstacles. Speech synthesis is used to provide information on environmental conditions and landmarks.

Embedded sensing is a navigation and localization framework that does not rely on GPS. Sensors are embedded at strategic locations in their environments. Sensor signals are used to perform navigation tasks. Embedded sensing systems typically rely on radio frequency sensors, infrared sensors, and ultrasonic sensors.

A Radio Frequency Identification (RFID) unit consists of three hardware components: an antenna, a transceiver with a decoder, and a transponder (RF tag) programmed with a unique ID. The antenna emits radio signals to activate tags within a certain range and to read and write data to and from them. The SpotOn system developed at the University of Washington (J. Highthower, R. Want, and G. Borriello, Spoton: An indoor 3d location sensing technology based on rf signal strength, Technical Report CSE-2000-02-02, University of Washington, 2000) is an RFID-based localization system for indoor environments. The system relies on the strength of the signal from RF tags and uses triangulation to estimate their positions. Another RFID-based navigation system for indoor environments was developed at the Atlanta Va. Rehabilitation R&D (D. A. Ross and B. B. Blasch, Development of a Wearable Computer Orientation System, IEEE Personal and Ubiquitous Computing, (6):49-63, 2002 and D. A. Ross, Implementing Assistive Technology on Wearable Computers, IEEE Intelligent Systems, (May):2-8, 2001). In this system, the blind users' canes are equipped with RFID receivers, while RFID transmitters are placed at hallway intersections. As the users pass through transmitters, they hear over their headsets commands like turn left, turn right, and go straight.

Attempts have been made to use the emerging ultrasonic sensor technology for localization and tracking in indoor environments. Ultrasonic receivers use time of arrival (TOA) readings to estimate the distance to transmitters. One prominent example is the BAT system developed at the AT&T Cambridge Research Laboratory (A. Harter, P. Hopper, P. Steggles, A. Ward, and P. Webster, The Anatomy of a Context-Aware Application, Wireless Networks, 1(1):1-16, 2001). In the BAT system, the sensors are placed on the ceiling to increase coverage and obtain sufficient accuracy. Hexamite's Local Positioning System (http://www.hexamite.com. Microcomputer's Bat Vision, Hexamite Corporation) is a commercially available indoor ultrasonic tracking system that is similar to the BAT system but allows greater flexibility in the placement of sensors.

Existing approaches are inadequate to the extent that they make a strict separation between indoors and outdoors. GPS-based solutions target outdoors, but do not consider how their users function indoors. Embedded sensing systems work primarily indoors, and leave it up to the user to figure out how to function outdoors. Most computer vision solutions require unobstructed views of landmarks and fiducials, which exposes them to the problems of direct line of sight approaches. Multiple sensors and sensor fusion can overcome this separation by leveraging the relative strengths and weaknesses of available sensors in different environments.

### SUMMARY

Disclosed is a multi-sensor navigation device. One embodiment of the device is wearable and will enable visually impaired individuals to navigate unfamiliar dynamic and complex environments, both indoors and outdoors. Sensor data are collected in the target environment at installation time. At run time, a computer interfaced to the sensors employs decision processing to determine location. The user can have the ability to input requests for directions to a new location. The current location of the user can be output to the user as well as directions to a desired location.

### DESCRIPTION OF THE FIGURES

FIG. 1 shows the hardware architecture of the wearable embodiment of the multi-sensor device.

FIG. 2 shows the pedometer interface.

FIG. 3 shows pedometer signal spikes during a walk.

FIG. 4 shows placements of the wearable device on the navigator's body.

FIG. 5 shows the GPS signal drift at a single location.

### DETAILED DESCRIPTION

Sensor fusion is the ability of a sensing device to integrate data from multiple sensors. The reality is that no sensor is foolproof. As of now, there is no single sensor that can function reliably both indoors and outdoors. Perceptual systems that do not fuse information from different sensors have a fundamental weakness: they cannot reduce uncertainty. Uncertainty arises from missed observations, missing features, sensor noise, or the inherent ambiguity of an observable percept. Active perception techniques, that attempt to reduce uncertainty through repeated observations cannot compensate for observations that are inherently incomplete or ambiguous. Different sensors, even when they measure the same percept, generate outputs that may have little in common. Thus, robust sensor fusion frameworks are critical to reducing ambiguity and making sense of disparate pieces of evidence. Existing approaches are inadequate to the extent that they make a strict separation between indoors and outdoors. GPS-based solutions target outdoors, but do not consider how their users function indoors. Embedded sensing systems work primarily indoors, and leave it up to the user to figure out how to function outdoors. Sensor fusion can overcome this separation by leveraging the relative strengths and weaknesses of available sensors in different environments. Since no sensor performs well in all environments, a robust wayfinding technology must take advantage of multiple sensors. One possible sensor uses IEEE 802.11b wireless signals in localizing mobile wireless signal receivers in indoor environments. The receiver runs several standard classification algorithms, e.g., an artificial neural network, a Bayesian classifier, an indictive decision tree classifier, etc., on the digitized wireless signals that it receives from wireless access routers deployed in the environment. The outputs from the individual classifiers are fused to make a localization decision.

Hardware Design

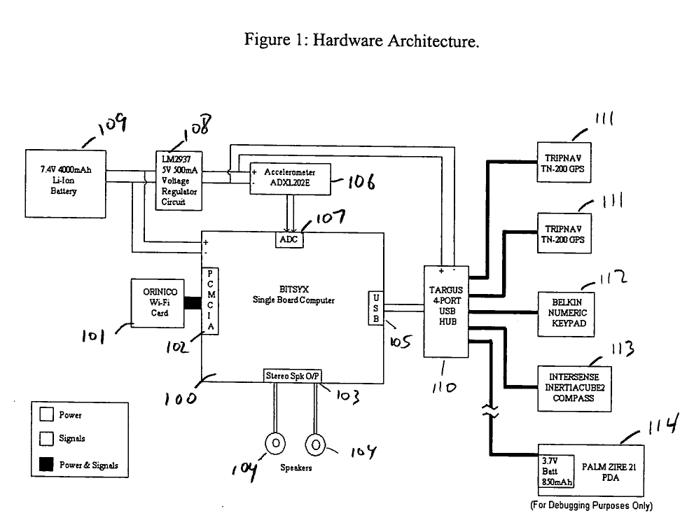

One embodiement of the wearable device consists of the following hardware components connected to each other as shown in FIG. 1. The computational unit [100], for example a Bitsy X single-board computer from Applied Data Systems, Inc (or other similar device). The Bitsy X is compact (dimensions: 3 by 5 inches) and has a 32-bit, 400MHz Intel PXA255 RISC processor with an SA-1111 StrongARM companion chip. It offers 64 MB of flash memory, a USB host [105] (for the GPS receiver, compass, and keypad), analog-to-digital converters [107] (ADCs) for the pedometer [106], a PCMCIA slot [102] for the wireless ethernet card [101], and two stereo speaker outputs [104]. In addition, it has several types of ports (serial, SPI, I2C, Digital I/O, etc) which can be utilized in future upgrades. It has a complete and partitioned on-board power supply [109, 108] (<1.5 W in operation) and supports development in Linux and WinCE.

A USB hub [110], for example a 4-port USB 2.0 Mobile Mini Hub from Targus Group International Inc. (or other similar device) is coupled with the USB host interface on the Bitsy X Connector Board and routes power and communication signals between the Bitsy X and the external sensors. A wireless card [101], for example an Orinoco© Classic Gold PC 802.11b wireless card (or other similar device) is inserted into the Bitsy X single board computer. A GPS USB receiver [111] plugs directly into the USB hub [110]. The GPS receiver [111] is for example a 3 TripNav TN-200 USB GPS receiver from the Rayming Corporation (or other similar device). To send data, the GPS receiver [111] uses a custom protocol or a standard protocol such as the National Marine Electronics Association (NMEA) protocol NMEA-0183. A second sensor [113], such as the Intersense InertiaCube2 from Intersense Inc. (or other similar device), a self-contained precision orientation reference system that includes a digital compass. This sensor is powered by the USB hub [110]. An input device [112], such as a 19-key external Numeric Keypad from Belkin Corporation (or other similar device) enables the user to interact with the Bitsy X (i.e., input the desired destinations, request feedback during navigation). The input device is connected via the USB hub [110].

The Bitsy X [100] requires an unregulated voltage input of between 6-16V from a Li-Ion battery source [109]. The other requirements for the application are small size, light weight, easy-to-find adapters, and at least 3 hours of continuous operation. The calculations indicate that, in the worst case, the power consumption specifications of the different hardware components lead to the capacity requirements of around 3000 mAh. Accordingly, a 7.2V 4000 mAh Li-Ion battery-pack (or other similar device) is used. An LM2937 low-dropout voltage regulator [108] from National Semiconductors, Inc. (or other similar device) is used to supply 5V regulated power to the USB hub [110] as well as the ADXL202EB accelerometer module [106] (or other similar device). The regulator requires two capacitors: one at the input and one at the output.

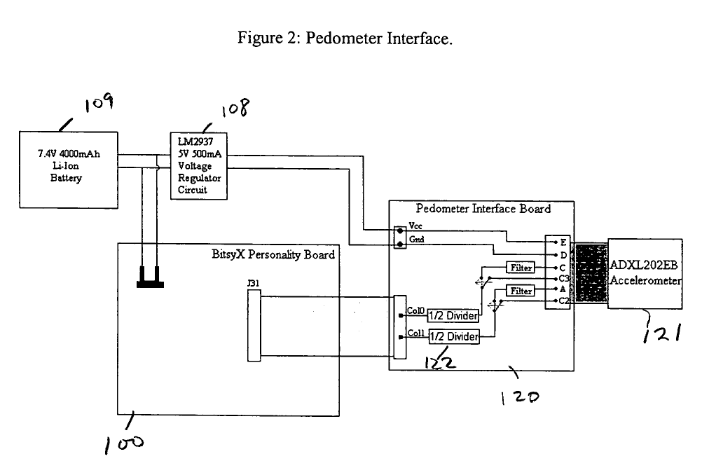

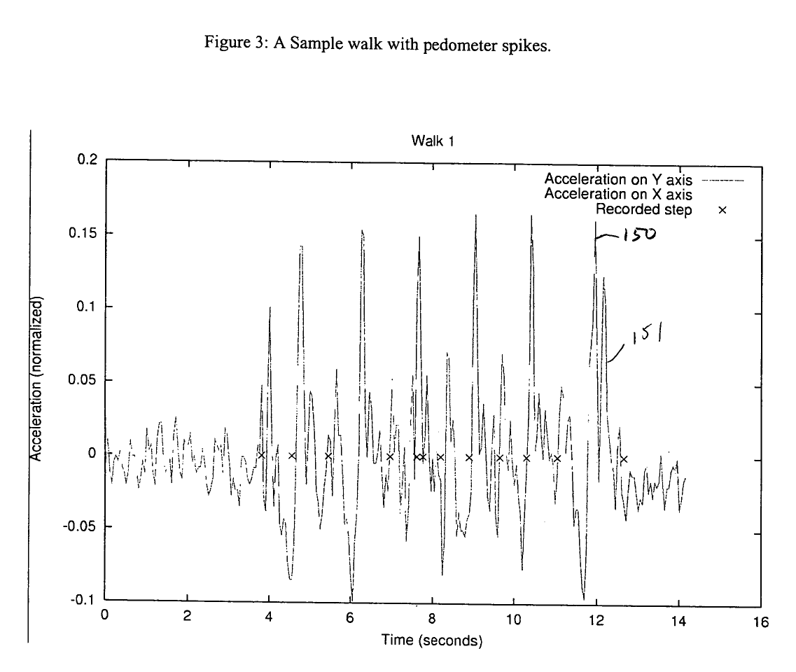

Sensors such as an ADXL202EB accelerometer evaluation module [121] from Analog Devices, Inc. can be interfaced to the ADC channels [107] on the Bitsy X [100], and a pedometer is implemented as a software module that digitizes the signals received from the accelerometer. The pedometer interface is shown in FIG. 2. The accelerometer measures acceleration along two perpendicular axes and provides pulse-width modulated (PWM) outputs as well as analog outputs. The PWM output signals are converted to analog signals via filtering [120]. The analog signals are dispatched to the ADC channels 0 and 1 on the ADSmartIO module [107] of the BitsyX [100]. The software module continuously polls the ADC values from the two ADC channels on the Bitsy X. The module is based on detecting signal spikes in the x [150] and y [151] acceleration planes. FIG. 3 shows a typical plot from a trial walk. The crosses represent key presses made by the user when his foot made contact with the ground. The light gray line represents acceleration measurements along the x-axis and the dark gray line represents acceleration measurements along the y-axis. The plot shows noticeable spikes depicting sudden changes in acceleration when the foot makes contact with ground. Spikes along the x-axis appear more often than those along the y-axis.

Wearability Designs

In one possible embodiment (design 1) of a wearable design the device is attached to a cloth harness with several industrial strength Velcro belts. The harness is placed around the user's shoulders in a manner similar to a baby carrier. The pedometer unit is placed on the user's arm. The GPS receiver, the digital compass, and an audio device, e.g., a small shoulder speaker, are placed on the shoulder straps.

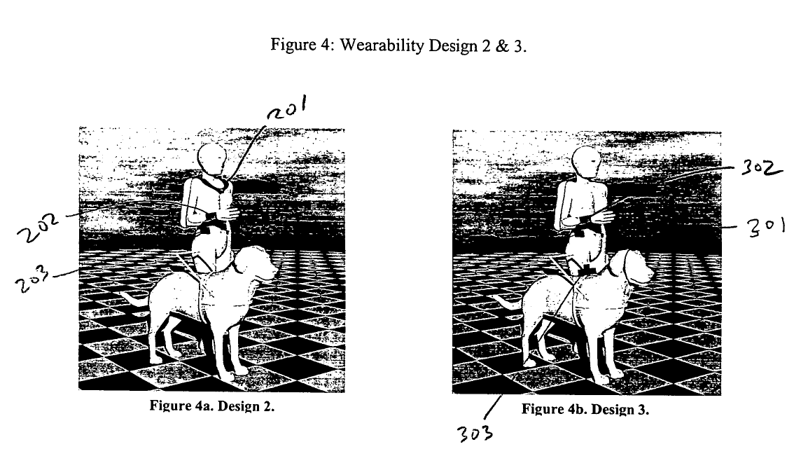

FIGS. 4a and 4b show two examples of wearability designs for visually impaired users. Both figures reflect the realistic sizes of the hardware components. In FIG. 4a, design 2, the BitsyX™ computer [100] with a wireless card [202] is placed on the user's arm [202]. The keypad [112] is placed on top of the computer. The computer [100] is connected to the GPS [111] and the digital compass [113] that reside on a Velcro cloth collar around the user's neck [201]. The collar is clipped to the user's clothing to prevent oscillation during walking. The audio delivery device resides either on the collar (a shoulder speaker) or on the user's head (bone conduction headphones or an over-ear headphone).

In FIG. 4b, design 3, the user wears one BitsyX™ computer and the audio delivery device [302] The guide dog wears another BitsyX™ computer with a wireless card [303]. The computer is attached to the dog's harness. The digital compass is placed on top of the dog's computer and the GPS unit is placed either on top of the dog's head, or on the dog's neck [301]. The placement of the digital compass on the dog's back is dictated by the fact that digital compasses may be affected by oscillation and the middle of the dog's back is the most stable position on the dog's body during navigation. GPS signals are not affected by oscillation, but can be occluded by a human body. Since during navigation the guide dog is trained to walk ahead of the user on the left, the placement of the GPS unit on the dog's head or neck ensures that GPS signals are not occluded. The compass and the GPS unit are USB-powered from the computer on the dog's back. The user's computer and the dog's computer are connected via a wireless local area network. This placement of sensors on the dog takes into account the physical characteristics of the three most common guide dog breeds: German Shepherd, Labrador Retriever, and Golden Retriever.

The designs are complementary. Design 1 can be used both in warm and cold weather. Design 2 is preferred for warm weather when the Velcro collar can be easily attached to a shirt, a dress, or a jacket. Design 3 is preferred for cold weather when it may be hard to place a collar on top of a bulky coat. All designs preserve ergonomic wearability and allow the user to carry backpacks.

Input and Output

The input into the system can be done in a number of ways. Two options are voice-based and haptic. The voice-based option consists of a wearable microphone coupled to a speech recognition engine that runs on the computational unit, e.g., the Bitsy X computer [100]. The speech recognition engine can be Microsoft's SAPI or IBM's ViaVoice. Other choices of speech recognition software will be recognized by anyone skilled in the art. The haptic option consists of a wearable keypad. The keypad's keys can be covered with Braille labels for easy of use by visually impaired navigators.

An output device is connected to the central processing unit to convey directions to the user or to solicit further input from the user. In one embodiment the output device is an audio output device. Headset, earphone or speaker or other are possible selections of audio output device. Example devices used for audio delivery are: bone conduction headphones (for example the TCI bone conduction headset from SOGear, Inc), an over-ear headphone (for example the Philips HS300 Over-Ear Headphone) and a shoulder speaker (for example the Standard Pillow Speaker from CCrane, Inc). Each of these options has advantages and disadvantages. The advantage of bone conduction is that the user's ears remain open. The bone conduction transducer converts electric signals into mechanical vibrations that stimulate the auditory nerves via bone oscillation and by-pass the eardrum. However, since bone conduction phones are typically placed on cheeks, they may not be suitable for individuals with beards or make-up. An over-ear headphone is lightweight and inconspicuous, but may block ambient sounds from the environment. A pillow speaker is extremely lightweight. However, since the sound is broadcast in the open, it may be harder to attend to and may draw the attention of other people in the environment. Each user can select the audio delivery option that suits him or her best. Other output means capable of communicating information to the user are possible including but not limited to visual outputs devices.

Sensor Fusion

Dempster-Shafer Theory (DST) is used as a theoretical framework for sensor fusion. The relative advantages and disadvantages of DST and Bayesian theory have been much debated in the literature. Attempts were made to reduce DST to the fundamental axioms of classical probability theory. However, belief functions, a fundamental concept underlying DST, have been shown not to be probability distributions over sample spaces. DST is used for the following three reasons. First, in DST, it is unnecessary to have precise a priori probabilities. In the context of wireless localization, this is an advantage, because the propagation of wireless signals indoors is affected by dead spots, noise, and interference. Second, Laplace's Principle of Insufficient Reason, i.e., a uniform distribution of equal probability to all points in the unknown sample space, is not imposed and, as a consequence, there is no axiom of additivity. Third, DST evidence combination rules have terms indicating when multiple observations disagree. Other operational methods for sensor fusion will be evident to one skilled in the art.

Knowledge about the world is represented as a set of elements, Θ, called the frame of discernment (FOD). Each element of Θ corresponds to a proposition. For example, Θ={θ₁, θ₂} can be a FOD for a coin tossing experiment so that θ₁ is heads and θ₂ is tails. Each subset of Θ can be assigned a number, called its basic probability number that describes the amount of belief apportioned to it by a reasoner. The assignment of basic probability numbers is governed by a basic probability assignment (BPA). Each BPA describes a belief function over Θ. A subset A of Θ is a focal point of a belief function Bel if m(A)>0. Suppose that m₁ and m₂ are two BPAs for two belief functions Bel₁ and Bel₂ over Θ, respectively. Let A₁, A₂, . . . , Aₖ, k>0 be the focal points of Bel1 and B₁, B₂, . . . , Bₙ, n>0 be the focal points of Bel₂. Then Bel₁ and Bel₂ can be combined through the orthogonal sum whose BPA is defined as follows:

$$m ( A ) = \frac{{\sum }_{{A}_{i} ⋂ {B}_{j} = A} {m}_{1} ( {A}_{i} ) {m}_{2} ( {B}_{j} )}{1 - {\sum }_{{A}_{i} ⋂ {B}_{j} = ∅} m ( {A}_{i} ) m ( {B}_{j} )}$$

Once the pairwise rule is defined, one can orthogonally sum several belief functions. A fundamental result of the DST is that the order of the individual pairwise sums has no impact on the overall result.

A simple support function S provides evidential support for one specific subset A of Θ. S is said to be focused on A. The function provides no evidential support for any other subset of Θ unless that set is implied by A, i.e., contains A as its subset. Formally, a simple support function S:2^{Θ}→[0,1], A≠Ø, A ⊂ Θ, is defined as follows:

$$S ( B ) = \{ \begin{matrix}0 , if A ⊄ B ; \\ s , if A ⊆ B , B \neq Θ ; \\ 1 , if A = Θ .\end{matrix}$$

In the above equation, s is in [0, 1]. If S is focused on A, S's BPAs are defined as follows: m(A)=S(A); m(Θ)=1−S(A); m(B)=0, if B≠A, B ⊂ Θ. A separable support function is the orthogonal sum of two or more simple support functions. Simple support functions can be homogeneous or heterogeneous. Homogeneous simple support functions focus on the same subset of È, whereas heterogeneous simple support functions focus on different subsets of Θ.

In one embodiment the signals received from the environment are processed through a classification algorithm (known to those skilled in the art), e.g., a Bayesian classifier, C4.5, an artificial neural network (ANN), etc. It is also assumed that the environment is represented in terms of a frame of discernment, Θ, that consists of the location symbols: {L₁, . . . , Lₙ}. The set of locations is exhaustive in the sense that these locations are the only locations of interest to the navigator.

At run time, a vector of sensor signals is classified with each of the available classification algorithms. Let X be a vector of sensor signals and let A₁, . . . , Aₙ be the available classification algorithms. Then Aᵢ (X) ⊂ Θ. Note that the output of a classification algorithm can be an empty set if the algorithm cannot classify a given input. The performance of each localization algorithm at Lᵢ is represented as a simple support function S_{B={L}_{ᵢ}_{}}^{A}^{ⱼ}, where B={Lᵢ} is the focus of S and Aⱼ is a localization algorithm. For example, if there are five locations and three localization algorithms, there are fifteen simple support functions: one simple support function for each location and each localization algorithm. At run time, given X, Aj(X) is computed for each Lᵢ and for each localization algorithm Aⱼ. If Aⱼ(X) is greater than a pre-selected threshold, S_{{L}_{ᵢ}_{}}^{A}^{ⱼ} ({Lᵢ})=sᵢⱼ, where sᵢⱼ is the basic probability number with which S supports its focus. Otherwise, S_{{L}_{ᵢ}_{}}^{A}^{ⱼ} ({Lᵢ})=0. The support for Lᵢ is computed as S_{{L}_{ᵢ}_{}}^{A}^{₁} ⊕S_{{L}_{ᵢ}_{}}^{A}^{₂} ⊕ . . . ⊕ S_{{L}_{ᵢ}_{}}^{A}^{ₙ}. After such orthogonal sums are computed for each location, the location whose orthogonal sum gives it the greatest support is selected. This method of combination is called homogeneous insomuch as the orthogonal sums are computed of simple support functions with the same focus.

There is another possibility of evidence combination. It is always possible to find the best localization algorithm for each location according to some criterion C, breaking the ties arbitrarily if necessary. Suppose that A₁, . . . , Aₙ are the best localization algorithms for each of the n locations. Note that the same algorithm can be best for several locations. Suppose further that these algorithms are represented as simple support function S_{{L}_{₁}_{}}, . . . , S_{{L}_{ₙ}_{}}. Given X, Aᵢ(X) is computed for each Lᵢ, where Aᵢ(X) is the output of the best algorithm for Lᵢ. If Aᵢ(A) is greater than some threshold, S_{{L}_{ᵢ}_{}}({Lᵢ})=sᵢ. Once each of the n support degrees are computed, the orthogonal sum S is computed. The result sum is heterogeneous, because each simple support function has a different focus. The best location is the location with the highest degree of support according to S.

If one is to represent each localization algorithm as a simple support function, the question arises as to how to assign the basic probability numbers with which each simple support function supports the location on which it is focused.

One method is to compute the basic probability numbers in terms of true and false positives and true and false negatives. Let T be the target location, i.e., the current location of the navigator wearing the wayfinding device. A true positive is defined as A(X)=L and T=L. A true negative is defined as A(X)≠L, T≠L . A false positive is defined as A(X)=L, T≠L . A false negative is defined as A(X)≠L, T=L.

Let TP, TN, FP, and FN be the number of true positives, true negatives, false positives, and false negatives, respectively. Using TP, TN, FP, and FN, one can define four evaluation statistics: sensitivity, specificity, positive predictive value (PPV), negative predictive value (NPV). Sensitivity, TP/(TP+FN), estimates the probability of A saying that the signal receiver is at location L given that the signal receiver is at location L, i.e., P[A(X)=L|T=L]. Specificity, defined as TN/(TN+FP), estimates the probability of A saying that the signal receiver is not at L given that the signal receiver is not at L, i.e., P[A(X)≠L|T≠L]. PPV, defined as TP/(TP+FP), estimates the probability that the receiver is at L given that A says that the receiver is at L, i.e., P[T=L|A(X)=L]. Finally, NPV, defined as TN/(TN+FN), estimates the probability that the signal receiver is not at L given that the algorithm says that the receiver is not at L, i.e., P[T≠L|A(X)≠L].

Indoor Navigation

The indoor localization is done by using non-GPS signals such as wireless signals already available in many indoor environments due to the ubiquitous use of wireless IEEE Wi-Fi networks. Other sensors such as RFID can be used in addition to or in substitution to wireless. One advantage of the wireless approach is that it does not require any modification of the environment, e.g., deployment of extra sensors or chips, which may negatively affect the designs of some organizations to make their environments more accessible to the visually impaired. The navigator is localized to a location. Once the navigator is localized to a location, the location specific behavior scripts are triggered to achieve a global navigation objective.

A set of landmarks is selected in a given target environment. Wireless signal strengths are detected and digitized. The wireless signature of each landmark consists of the signal strengths from the wireless access points detected in the environment. Once collected at a landmark, the signal strengths are processed with a neural network. At run time, signal strengths are classified to a landmark.

There is a wide selection of wireless receivers available that can be used to perform the wireless signal discretization. An Orinoco 11b Classic PC Card Gold (8410-WD) by Proxim, Inc. was used to take the trail data. The card can be used anywhere to connect to a Wi-Fi network. The card delivers high-speed wireless networking at 11 Mbit/s, operating in the 2.4 GHz unlicensed frequency. An alternative is the Orinoco 11b USB Adapter Gold (8424-WD) also manufactured by Proxim, Inc. This is a secure 802.11b wireless connectivity that connects a computer to any compliant 802.11b Wi-Fi network. The adapter provides 11 Mbit/s operation in the 2.4 GHz license free frequency band. Other similar Wi-Fi devices and other manufacturer sources can be substituted and used to perform the wireless signal detection function. It is also clear to anyone skilled in the art that a computational unit different from the Bitsy X single board computer can be chosen to perform computation. Further reduction in size can be accomplished by incorporating the CPU into the control electronics without excess size and weight of the monitor and full keyboard.

Route Planning and Tracking

Path planning is the ability of the system to plan routes to desired destinations. Tracking refers to the system's ability to track the user's progress on a path to a desired destination. To support path planning a map of the environment is created in the form of a connectivity graph where nodes represent locations and edges path between locations. The edges may also specify distances between locations. Thus, the environment is represented by a connected graph.

The map file consists of first-order predicate calculus propositions that describe the graph's connectivity. Given the start and end destinations, a variety of path planning algorithms can be used to find a path, e.g., breadth first search, A*-search, etc. It is clear to anyone skilled in the art that other path planning algorithms can be used for this task. In the current embodiment of the system, the path planner is realized as a breath first search. Thus, the found path is shortest in terms of number of locations encountered and not necessarily in terms of distance traveled.

At run time, wireless signal classifiers localize the navigator to individual locations. However, to track the navigator's progress on the path, it is necessary to determine when the navigator is in between locations. As the navigator moves from location X towards location Y, the wireless signal strengths change so that the number of occurrence of Y detected by the classifier increases and the number of detected occurrences of X decreases. This change is referred to as a switch. The switch, when detected, tells the system that the navigator is between two given locations. For example, when the navigator is moving from location 1 to location 2 and is one-third of the hallway between 1 and 2, a switch is detected as soon as location 2 is detected. Thus, the detection of switches allows the system to keep track of the user's progress not only at individual locations but also in between pairs of connected locations.

Preliminary Experiments

The target environment for localization experiments was the Utah State University Computer Science (CS) Department. The department occupies an indoor area of approximately 6,590 square meters. The floor contains 23 offices, 7 laboratories, a conference room, a student lounge, a tutor room, two elevators, several bathrooms, and two staircases. Five wireless access points (routers) were deployed at various offices in the USU CS Department. The wireless routers were D-Link 802.11g/2.4 GHz wireless routers. Other wireless routers can be used as well.

Each location was selected at a corner, because in indoor environments corners are very useful decision points. Each location had several (two or more) collection positions marked. A collection position was the actual place where wireless signal strengths were collected. Each collection position was located 1.5 meters away from a corner. The width of the hall determined how many collection positions were needed. If the hall was narrow (width<2 meters), only one collection position was chosen in the middle of the hall. If the hall was wider than 2 meters, then there were two collection positions, which were positioned to divide the hall width into thirds.

A total of 13 collection positions were chosen for the five selected locations. Thus, each location corresponded to at least two collection positions. Two sets of samples were taken at each collection position, one for each direction of the hall's orientation. So, for example, if a hall's orientation was from north to south, two sets of samples were collected: one facing north, the other facing south. A set of samples consisted of two minutes worth of data. An individual sample was a set of five wireless signal strengths, one from each wireless access point in the department. Samples were collected at a rate of approximately one sample every ten microseconds. Different sets of data for a single collection position were collected on different days in order to see a wider variety of signal strength patterns. Each collection position and direction combination had 10 total sets of data, which amounted to a total of twenty minutes worth of data. Therefore, the total data collection time was 260 minutes, which resulted in a total of 1,553,428 samples. These samples were used for training purposes.

To obtain the validation data, the route that contained all the selected locations was navigated 5 times in each direction. Four pieces of masking tape were placed at each collection position: two at 0.5 meter from the collection position and two at 1 meter from the collection position. The pieces of tape marked the proximity to the collection position, i.e., the robot is within 0.5 meter of the collection position and the device is within 1 meter of the collection position. As the device crossed a tape, a human operator following the robot would press a key on a wearable keypad to mark this event electronically. Thus, in the validation file, the readings at each position were marked with the proximity to that position. People were present in the environment during the test runs.

Five wireless access points were placed at various locations in the USU Computer Science (CS) Department. Data were collected for five different locations. A single reading in both the training data and the validation data consisted of the signal strength for each wireless access point. The signal strengths were taken every 10 microseconds. When collecting the training data, the user stood 1.5 meters from the actual location for two minutes at a time. The laptop with the wireless card was placed on the user's back. Since the human body affects signal strength, data were collected twice at each collection position, once for each direction of the hall. Data were collected over 10 days in the two minute increments, resulting in a total of 20 minutes worth of data for each direction of a hall at each location. If the hall was less than 2 meters wide, then only one collection position was used. Otherwise, two collection positions were used in order to account for the larger area in which a person could walk. The neural network method used five networks, one for each corner. Each network consisted of 4 layers: the input layer with five inputs, one for each access point, two hidden layers with 10 nodes each, and an output layer with one node. The network was fully connected and trained using backpropagation. The location whose network reported the highest output value, was reported as the classification for that set of signal strengths.

The validation data were collected during walks. Four tape markings were placed on the floor on two sides of each location so that when walking past a location a user would walk over all four markings. Two markings were placed a half meter on each side of the collection position and two markings were placed one meter on each side of the collection position. The user walked from location 1 to location 5, and as he walked, he used the system to record each time he walked over a tape marking. During the entire walk signal strengths were recorded. The evaluation results are shown in Table 1. Neither the pedometer nor the digital compass was used in the experiments.

TABLE 1
Neural Network Performance at 5 Locations.

| | Location 1 | Location 2 | Location 3 | Location 4 | Location 5 |
|---|---|---|---|---|---|
| Sensitivity | 0.92 | 0.96 | 0.68 | 0.76 | 0.96 |
| Specificity | 0.99 | 0.98 | 0.96 | 0.94 | 0.97 |
| PPV | 0.99 | 0.94 | 0.81 | 0.77 | 0.90 |
| NPV | 0.98 | 0.99 | 0.92 | 0.94 | 0.99 |

Table 1 consists of 4 rows and 5 columns. The names of the rows are Sensitivity, Specificity, Positive Predictive Value (PPV), and Negative Predictive Value (NPV). The names of the columns are Location 1, Location 2, Location 3, Location 4, and Location 5. Sensitivity is the probability that the localization method says that the signal receiver is at location L, given that the signal receiver is at location L. Specificity is the probability that the localization method says that the signal receiver is not at the location L, given that the signal receiver is not at the location L. Positive Predictive Value is the probability that the signal receiver is at location L, given that the localization method says that the signal receiver is at location L. Negative Predictive Value is the probability that the signal receiver is not at location L, given that the localization method says that the signal receiver is not at location L. The values in the first column are 0.92, 0.99, 0.99, 0.98. The values in the second column are 0.96, 0.98, 0.94, and 0.99. The values in the third column are 0.68, 0.96, 0.81, and 0.92. The values in the fourth column are 0.76, 0.94, 0.77, and 0.94. The values in the fifth column are 0.96, 0.97, 0.90, and 0.99.

As shown in Table 1, the localization performance was 90% or above at locations 1, 2, and 5. The performance at locations 3 and 4 ranged from 70% to 96%. Subsequent analysis of data revealed that the signal strengths of most access points at those locations are the same and cannot be distinguished by the neural network at run time. The reason for this is that the two locations are within 3.5 meters of each other.

A valuable insight obtained from the experiments was that for the localization accuracy to be maximized, landmarks must be chosen so that they do not reside in the close physical proximity of each other. Other classification algorithms, e.g., C4.5 and Bayes can be used to analyze the data.

Outdoor Navigation

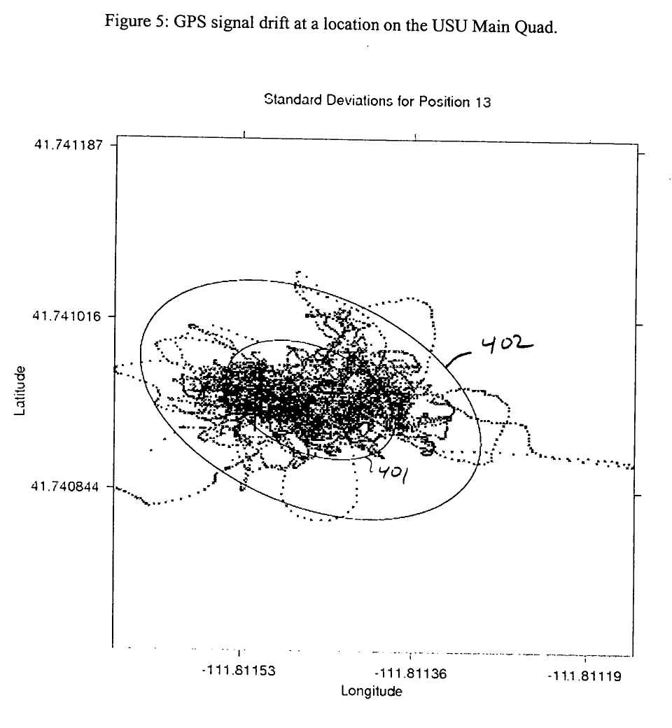

Modern GPS receivers are simple to operate, inexpensive, and commercially available. However, studies show that GPS-based localization has a great degree of inconsistency outdoors. The principal problem with GPS is signal drift, which may result in localization errors of up to 100 meters. FIG. 5 shows the signal drift area at a single location. The total area of the drift is 43 meters in longitude and 28 meters in latitude. The proposed multi-sensor device realizes a localization method that exploits the regularities in signal drift in a given area. The method is based on the observation that while the latitude and longitude for a given position drift over time, they tend to remain within a limited area.

Virtual Landmarks

Instead of matching a single GPS reading to an actual position on the map, a virtual landmark is created based on the standard deviation of the drift. In one embodiment, standard deviation ellipses are computed for each selected landmark. Since, during navigation, single GPS readings are no longer mapped to single positions on the map, localization error is greatly reduced. Each landmark is associated with an ellipse based on the standard deviation of several readings taken at that location.

Once the data collection is completed, the standard deviation ellipses are computed using dispersion point pattern techniques. First, the mean center is calculated. The mean center for a collection of N coordinates is the X-Y coordinate, where X is the average of the longitudinal readings and Y is the average of the latitudinal readings. To reflect the true spread of the data, a rotated ellipse is used. The ellipse is rotated around the mean center with the long axis representing the direction of maximum dispersion and the short axis representing the direction of minimum dispersion. As defined in Equation 1, the ellipse's angle of rotation, Θ (theta), represents the angle in a clockwise direction from the y axis. The standard deviations along the x-axis of the ellipse, σₓ, and the y axis of the ellipse, σ_{y}, are calculated using Levine's formula given in Equation 2.

$$Equation 1 \text{:}$$

$$Theta Equation$$

$$Θ = arctan ( \frac{\sum {x}^{′2} - \sum {y}^{′2} + \sqrt{{( \sum {x}^{′2} - \sum {y}^{′2} )}^{2} + 4 {( \sum {x}^{′} {y}^{′} )}^{2}}}{2 \sum {x}^{′} {y}^{′}} )$$

In Equation 1, x prime and y prime represent the transpose of each coordinate given by:
x′=xᵢ− X̅
y′=yᵢ− Y̅

$$Equation 2 \text{:}$$

$$Levine ' s Equations$$

$${σ}_{x} = \sqrt{\frac{\sum {( {x}^{′} cos Θ - {y}^{′} sin Θ )}^{2}}{N}}$$

$${σ}_{y} = \sqrt{\frac{\sum {( {x}^{′} sin Θ - {y}^{′} cos Θ )}^{2}}{N}}$$

To collect the data for the ellipses, 12 positions were identified within an example 2080 square meter area. All 12 positions are located on the two orthogonal sidewalks. Each position is located 3 meters from a turn, which allows for sufficient time to give an advanced warning to the user about a turn. At each position, two sets of readings are taken: one on each side of the sidewalk. These two sets are combined into one large set of readings which are used to create the standard deviation ellipses. Since the readings are on each side of the sidewalk, the ellipse covers the entire area between the two points, creating the virtual position through which the user will walk with a GPS receiver.

Preliminary Experiments

GPS readings were obtained at a rate of approximately one reading per second. The GPS unit was placed at each side location on both sides of the sidewalk for ten minutes at a time. This was repeated six times for each spot, resulting in one hour of data for each side of the sidewalk, or two hours of total data for each position. A total of six days were required to collect the data for each position. Once the data collection was completed, the standard deviation ellipses were computed according to the formulas in the above section. The GPS receiver used in the experiments was a TripNav TN-200 GPS Receiver from the Rayming Corporation.

The method was tested using 12 positions. For each position the maximum distance east, west, north, and south from the mean center was calculated using the first and second standard deviation ellipses for each position (See FIG. 5). The distances were then marked from the position where the data was originally collected. Only the distances for each position's appropriate direction were marked. This resulted in four markings for each position.

Two users then walked several routes through the marked area. Each user walked five different routes, 3 straight routes and 2 routes with a turn. When the user passed over a distance marking for a given position, they pressed a button to indicate that they had passed over the marking. This allowed the system to save the fact that they were between the 2 markings for the second standard deviation distance and also between the 2 markings for the first standard deviation distance. The collected data were processed off-line so that each GPS reading was evaluated to determine if it was inside a standard deviation ellipse. A total of 10 walks were performed with each walk passing through six ellipses. An intersection was defined as at least one GPS coordinate being inside an ellipse. Out of a total of 60 possible intersections with the set of second standard deviation ellipses, there were 60 intersections total, or 100% correct intersections. The walk paths intersected with 54 out of the 60 first standard deviational ellipses, an accuracy of 90%. While several of the paths missed the first standard deviation ellipses, all of them succeeded in intersecting with the second standard deviation ellipses. These experiments are not meant to be limiting the scope or application of the invention but are meant to demonstrate performance in a test situation.

### Additional Embodiments and Sensor Choices

A multi-sensor wayfinding device can also be mounted on robotic bases and enhanced with different sensors. Specifically, if the base operates in indoor environments, the robotic base can be enhanced with range finding devices, such as sonars and laser range finders, radio frequency identification (RFID) readers and antennas, and barcode readers.

In one embodiment of the system, the multi-sensor wayfinding device is mounted on top of a commercial robotic platform from the ActivMedia Corporation. The platform has three wheels, two drive wheels in the front and a steering wheel in the back, and is equipped with three rechargeable Power Sonic PS-1270 onboard batteries. The wayfinding device is mounted on top of the platform and powered from the on-board batteries. The device resides in a pipe structure attached to the top of the platform. The device includes a Dell Ultralight X300 laptop connected to the platform's microcontroller, a SICK LMS laser range finder from SICK, Inc., and a TI Series 2000 radio-frequency identification (RFID) reader from Texas Instruments, Inc.

The laptop interfaces to the RFID reader through a USB-to-serial cable. The reader is connected to a square 200 mm by 200 mm RFID RI-ANT-GO2E antenna that detects RFID sensors (tags) placed in the environment. TI RFID Slim Disk tags are the types of tags currently used by the system. These tags can be attached to any objects in the environment or worn on clothing. They do not require any external power source or direct line of sight to be detected by the RFID reader. They are activated by the spherical electromagnetic field generated by the RFID antenna with a radius of approximately 1.5 meters. Other RFID readers, antennas, and tags can also be used.

A demonstrative application is grocery shopping. Grocery shopping is a routine activity that people all over the world perform on a regular basis. However, grocery stores and supermarkets remain largely inaccessible to people with visual impairments. The main barrier is the inadequacy of the principal navigation aids, such as guide dogs and white canes, for negotiating the seemingly simple topological structure of a typical grocery store. While guide dogs are helpful in micro-navigation, e.g., local obstacle avoidance and homing in on simple targets such as exit doors, they offer little assistance with macro-navigation, which requires topological knowledge of the environment. A guide dog may memorize routes to a small set of grocery items through repeated exposure to those routes. However, the guide dog cannot help its handler in a routine situation when the store changes the location of several items between visits or stops carrying a product. Nor can the dog assist its handler with pushing a shopping cart. The white cane does not fare any better under the same circumstances. One embodiment of the invention is thus a robotic shopping cart for the visually impaired. The purpose is to assist visually impaired customers in navigating the store and carrying the purchased items around the store and to the check-out registers.

This embodiment's software architecture currently includes three components: a user interface (UI), a path planner, and a behavior manager. The UI's input is entered by the user from a hand-held keypad. The UI's output mode uses speech synthesis. Destinations entered by the user from the keypad are turned into goals for the path planner. The user can learn the available commands from a Braille directory, a roll of paper with Braille signs, that attaches to the handle at the back of the robot. The directory contains a mapping of key sequences to destinations, e.g., produce, deli, coffee shop, etc.

The path planner and behavior manager partially implement Kupiers' Spatial Semantic Hierarchy (SSH). The SSH is a framework for representing spatial knowledge. It divides spatial knowledge of autonomous agents, e.g., humans, animals, and robots, into four levels: the control level, causal level, topological level, and metric level. The control level consists of low level mobility laws, e.g., trajectory following and aligning with a surface. The causal level represents the world in terms of views and actions. A view is a collection of data items that an agent gathers from its sensors. Actions move agents from view to view. The topological level represents the world's connectivity, i.e., how different locations are connected. The metric level adds distances between locations.

The path planner realizes the causal and topological levels of the SSH. It contains the declarative knowledge of the environment and uses that knowledge to generate paths from point to point. The behavior manager realizes the control and causal levels of the SSH. The control level is implemented with the following low-level behaviors all of which run on the WT laptop: follow-aisle, turn-left, turn-right, avoid-obstacles, and make-u-turn.

The behavior manager also keeps track of the robot's global state. The global state is shared by all the modules. It holds the latest sensor values, which include the laser range finder readings, the last detected RFID tag, current velocity, current behavior state, and battery voltage. Other state parameters include: the destination, the command queue, the plan to reach the destination, and internal timers. The other modules use the current state in two ways: 1) to access and update the latest sensor readings and 2) to post messages for other modules.

Other potential embodiments of this technology may include service robotic bases operating in indoor environments, such as wheelchairs, walkers, inventory tracking robots, and delivery vehicles. Additional embodiments not delineated herein will be evident to those skilled in the art and are within the scope the present invention.

What is claimed is:

1. A wayfinding device comprising in combination;
at least two sensors,
a computer processing unit connected to said sensors,
a database of sensor outputs correlated to known positions,
a software means operating on said computer to calculate position from the
output of said sensors when combined with the said database, and
a means to output calculated position information.

2. The wayfinding device of claim 1 further comprising;
a means to input data or requests to the computer.

3. The wayfinding device of claim 1 wherein;
one of the said sensors is a GPS sensor.

4. The wayfinding device of claim 1 wherein;
one of the said sensors is a RFID reader.

5. The wayfinding device of claim 1 wherein;
one of the said sensors is a Wi-Fi wireless network sensor.

6. The wayfinding device of claim 1 wherein;
one of the said sensors is a digital compass.

7. The wayfinding device of claim 1 wherein;
the device is wearable by the user.

8. The wayfinding device of claim 1 wherein;
the device is wearable on a guide dog.

9. The wayfinding device of claim 1 wherein;
the device is wearable in part on the user and in part on a guide dog.

10. The wayfinding device of claim 1 further comprising;
a robotic self propelled platform.

11. The wayfinding device of claim 1 further comprising;
a sensor to determine proximity of objects or people.

12. A wayfinding device comprising in combination;
a GPS sensor,
a Wi-Fi wireless network sensor,
a central processing unit connected to said GPS sensor and to said Wi-Fi wireless network sensor,
a database of said GPS sensor outputs correlated to known positions connected to said central processing unit,
a database of said Wi-Fi wireless network sensor outputs correlated to known positions connected to said central processing unit,
a software means operating on said central processing unit to calculate position information from the output of said sensors when combined with the said databases, and
an audio output device connected to said central processing unit.

13. The wayfinding device of claim 12 wherein;
the said central processing unit comprises multiple digital processing units.

14. A method for locating position which comprises;
measuring signals from at least two sensors,
processing said signal measurements to determine position using a database of
sensor outputs correlated to known positions, and
outputting said position information.

15. The method of claim 14 which further comprises;
inputting a desired destination,
computing a path to said destination, and
outputting instructions to navigate to said destination.

16. The method of claim 14 wherein;
one of the said input data sources is a GPS sensor.

17. The method of claim 14 wherein;
one of the said input data sources is a RFID reader.

18. The method of claim 14 wherein;
one of the said input data sources is a Wi-Fi wireless network sensor.

19. The method of claim 14 wherein;
one of the said input data sources is a digital compass.

20. The method of claim 14 which further comprises;
an input data source to determine proximity of objects or people.
